(19) United States
(12) Patent Application Publication
(10) Pub. No.: US 2015/0036249 A1
(43) Pub. Date: Feb. 5, 2015

(54) PROTECTION CIRCUIT FOR POWER SUPPLY UNIT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: BO TIAN, Shenzhen (CN); KANG WU, Shenzhen (CN)

(21) Appl. No.: 14/449,342

(22) Filed: Aug. 1, 2014

(30) Foreign Application Priority Data
Aug. 1, 2013 (CN) 2013103307125

(51) Int. Cl. H02H 9/02

(52) U.S. Cl. CPC H02H 9/02
USPC 361/57

(57) ABSTRACT

A protection circuit is coupled between a power supply unit and a device. The protection circuit includes a delay circuit, a power circuit, a switch circuit, and a determining circuit. The power supply unit supplies power to the device through the power circuit when the device works normally. The delay circuit receives a power good signal and outputs the power good signal after a preset period of time to the switch circuit. The switch circuit energizes the determining circuit when the switch circuit receives the power good signal. The determining circuit outputs a control signal to the power circuit to disconnect the power supply unit from the device when the device is short-circuited.

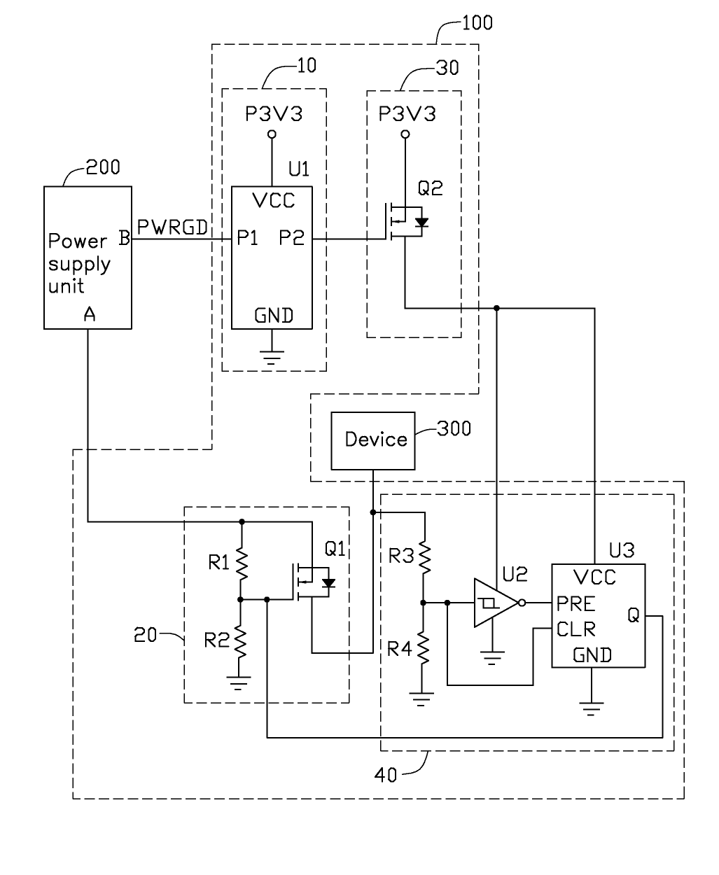

### FIELD

The subject matter herein generally relates to a protection circuit.

### BACKGROUND

A power supply unit of a computer supplies power to a device which is externally connected to the computer. The power supply is coupled to ground when the device is short-circuited.

### BRIEF DESCRIPTION OF THE DRAWINGS

Implementations of the present technology will now be described, by way of example only, with reference to the attached FIGURE.

The FIGURE is a circuit diagram of an embodiment of a protection circuit for a power supply unit.

### DETAILED DESCRIPTION

It will be appreciated that for simplicity and clarity of illustration, where appropriate, reference numerals have been repeated among the FIGURE to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawing is not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a protection circuit 100.

The FIGURE illustrates an embodiment of the protection circuit 100, a power supply unit 200, and a device 300 which receives power from the power supply unit 200. The protection circuit 100 is coupled between the power supply unit 200 and the device 300. The protection circuit 100 can comprise a delay circuit 10, a power circuit 20, a switch circuit 30, and a determining circuit 40.

The delay circuit 10 can comprise a single chip U1. A power pin VCC of the single chip U1 is coupled to a power supply P3V3. A ground pin GND of the signal chip U1 is coupled to ground. A first input output pin P1 of the signal chip U1 is coupled to a signal pin B of the power supply unit 200 for receiving a power good signal from the power supply unit 200. A second input output pin P2 of the signal chip U1 is coupled to the switch circuit 30. When the first input output pin P1 of the signal chip U1 receives the power good signal, the second input output pin P2 of the signal chip U1 outputs the power good signal to the switch circuit 30 after a preset period of time.

The power circuit 20 can comprise resistors R1, R2 and an electronic switch Q1. A control terminal of the electronic switch Q1 is coupled to a voltage output pin A of the power supply unit 200 through the resistor R1. The control terminal of the electronic switch Q1 is also coupled to ground through the resistor R2. A first terminal of the electronic switch Q1 is coupled to the voltage output pin A of the power supply unit 200 for receiving a voltage signal from the power supply unit 200. A second terminal of the electronic switch Q1 is coupled to the determining circuit 40 and the device 300. The control terminal of the electronic switch Q1 is also coupled to the determining circuit 40.

The switch circuit 30 can comprise an electronic switch Q2. A control terminal of the electronic switch Q2 is coupled to the second input output pin P2 of the signal chip U1. A first terminal of the electronic switch Q2 is coupled to the power supply P3V3. A third terminal of the electronic switch Q2 is coupled to the determining circuit 40.

The determining circuit 40 can comprise resistors R3, R4, a Schmitt trigger U2, and a D trigger U3. An input terminal of the Schmitt trigger U2 is coupled to the second terminal of the electronic switch Q1 through the resistor R3. The input terminal of the Schmitt trigger U2 is also coupled to ground through the resistor R4. A power terminal of the Schmitt trigger U2 is coupled to the second terminal of the electronic switch Q2. A ground terminal of the Schmitt trigger U2 is coupled to ground. An output terminal of the Schmitt trigger U2 is coupled to an input terminal PRE of the D trigger U3. A clear terminal CLR of the D trigger U3 is coupled to the input terminal of the Schmitt trigger U2. A power terminal VCC of the D trigger U3 is coupled to the power terminal of the Schmitt trigger U2. A ground terminal GND of the D trigger U3 is coupled to ground. An output terminal Q of the D trigger U3 is coupled to the control terminal of the electronic switch Q1.

The electronic switch Q1 is turned on when the control terminal of the electronic switch Q1 receives the voltage signal from the voltage output pin A of the power supply unit 200. The power supply unit 200 supplies power to the device 300 through the first terminal and the second terminal of the electronic switch Q1. The first input output pin P1 of the signal chip U1 receives the power good signal from the signal pin B of the power supply unit 200, and the second input output pin P2 of the signal chip U1 outputs the power good signal to the switch circuit 30 after a preset period of time. When the switch circuit 30 receives the power good signal, the electronic switch Q2 is turned on. The power terminal of the Schmitt trigger U2 and the power terminal VCC of the D trigger U3 are energized by the power supply P3V3.

The input terminal of the Schmitt trigger U2 and the clear terminal CLR of the D trigger U3 receive a high level signal from the device 300 when the device 300 works normally. The input terminal PRE of the D trigger U3 receives a low level signal from the output terminal of the Schmitt trigger U2, and the output terminal Q of the D trigger U3 outputs a high level signal to the control terminal of the electronic switch Q1. The electronic switch Q1 is turned on continuously.

The input terminal of the Schmitt trigger U2 and the clear terminal CLR of the D trigger U3 receive a low level signal from the device 300 when the device 300 is short-circuited. The input terminal PRE of the D trigger U3 receives a high level signal from the output terminal of the Schmitt trigger U2, and the output terminal Q of the D trigger U3 outputs a low level signal to the control terminal of the electronic switch Q1. The electronic switch Q1 is turned off The power supply unit 200 is disconnected from the power to the device 300 and prevents the power supply unit 200 from shorting.

In at least one embodiment, the electronic switches Q1, Q2 can be N-channel field effect transistors.

The embodiment shown and described above is only an example. Many details are often found in the art such as the other features of a management device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiment described above may be modified within the scope of the claims.

What is claimed is:

1. A protection circuit coupled between a power supply unit and a device, the protection circuit comprising:
a delay circuit coupled to a signal pin of the power supply unit;
a power circuit coupled between the power supply unit and the device;
a switch circuit coupled to the delay circuit; and
a determining circuit coupled to the switch circuit and coupled to the power circuits;
wherein the power supply unit supplies power to the device through the power circuit when the device works normally;
the delay circuit is configured to receive a power good signal and outputs the power good signal to the switch circuit after a preset period of time;
the switch circuit is configured to energize the determining circuit when the switch circuit receives the power good signal; and
the determining circuit is configured to output a control signal to the power circuit to disconnect the power supply unit from the device when the device is short-circuited.

2. The protection circuit of claim 1, wherein the delay circuit comprises a single chip, a power pin of the single chip is coupled to a power supply, a ground pin of the signal chip is coupled to ground, a first input output pin of the signal chip is coupled to a signal pin of the power supply unit for receiving the power good signal from the power supply unit, and a second input output pin of the signal chip is coupled to the switch circuit.

3. The protection circuit of claim 2, wherein the power circuit comprises a first resistor, a second resistor, and a first electronic switch, a control terminal of the first electronic switch is coupled to a voltage output pin of the power supply unit through the first resistor, the control terminal of the first electronic switch is also coupled to ground through the second resistor, a first terminal of the first electronic switch is coupled to the voltage output pin of the power supply unit for receiving a voltage signal form the power supply unit, a second terminal of the first electronic switch is coupled to the determining circuit and the device, and the control terminal of the first electronic switch is also coupled to the determining circuit.

4. The protection circuit of claim 3, wherein the switch circuit comprises a second electronic switch, a control terminal of the electronic switch is coupled to the second input output pin of the signal chip, a first terminal of the electronic switch is coupled to the power supply, and a third terminal of the electronic switch is coupled to the determining circuit.

5. The protection circuit of claim 4, wherein the switch circuit comprises a third resistor, a fourth resistor, a Schmitt trigger, and a D trigger, an input terminal of the Schmitt trigger is coupled to the second terminal of the first electronic switch through the third resistor, the input terminal of the Schmitt trigger is also coupled to ground through the fourth resistor, a power terminal of the Schmitt trigger is coupled to the second terminal of the second electronic switch, a ground terminal of the Schmitt trigger is coupled to ground, an output terminal of the Schmitt trigger is coupled to an input terminal of the D trigger, a clear terminal of the D trigger is coupled to the input terminal of the Schmitt trigger, a power terminal of the D trigger is coupled to the power terminal of the Schmitt trigger, a ground terminal of the D trigger is coupled to ground, and an output terminal of the D trigger is coupled to the control terminal of the first electronic switch.

6. The protection circuit of claim 4, wherein the first and second electronic switches are N-channel field effect transistors.
